(19) United States
(12) Patent Application Publication
(10) Pub. No.: US 2008/0231752 A1
(43) Pub. Date: Sep. 25, 2008

(54) Method for generating a clear frame from an image frame containing a subject disposed before a backing of nonuniform illumination

(75) Inventor: Paul Ernest Vlahos, Tarzana, CA (US)

Correspondence Address: BLAKELY SOKOLOFF TAYLOR & ZAFMAN LLP, 1279 OAKMEAD PARKWAY, SUNNYVALE, CA, 94085-4040, US

(73) Assignee: iMatte, Inc.

(21) Appl. No.: 11/726,754

(22) Filed: Mar. 22, 2007

(51) Int. Cl. H04N 9/74

(52) U.S. Cl. 348/587; 348/E09.055

(57) ABSTRACT

A method for extracting a clear frame from an image frame containing at least one or more subjects disposed before a backing, whose color and luminance vary smoothly from one backing area to another. The method replaces a subject's pixel signal levels with backing pixel signal levels. The method selects a known backing pixel and compares the RGB signal levels of an adjacent pixel with the RGB signal levels of the known backing pixel and identifies the adjacent pixel as a backing pixel when its RGB signal levels are each within an assigned tolerance of the RGB signal levels of the known backing pixel. This comparison is performed on all known backing pixels with unidentified adjacent pixels until all pixels in the image frame have been examined and all backing pixels identified. The method then replaces the RGB signal levels of the at least one subject's pixels with the RGB signal levels of backing pixels located at opposite edges of said at least one subjects by at least one of interpolation and or extrapolation across the at least one subject thereby removing said at least one subject to leave a clear frame.

### BACKGROUND

The use of a Blue Screen process for generating a composite image is frequently used in motion picture and television productions as well as still photographs. One of the always present problems with this process is the lack of uniformity in the illumination of the colored backing. The very best composite images are obtained when the backing illumination is quite uniform in both luminance and color. It can take many hours moving and adjusting the several lamps used in the vain attempt to obtain uniform illumination, especially of a large backing.

Several methods have been developed for correcting the non uniformity of a colored backing, when using a camera whose position is fixed. A camera view of the blue backing before the actors enter the camera's field of view is called a “clear frame”, or “clean plate”, containing nothing but the blue backing. This clear frame is placed in memory.

The RGB levels of the clear frame are compared with the RGB levels of an ideal blue screen, a screen that may never exist, whose color is perfect and is being perfectly illuminated. The differences between the actual screen and an ideal screen become correction factors, and are added to backing pixels to make the screen look perfectly uniform to the compositing logic. This is the method of screen correction used in U.S. Pat. No. 5,032,901. It requires the generation of a clear frame, which is valid only so long as the camera does not move.

U.S. Pat. No. 5,424,781 provides backing correction but also requires the actor to be removed from camera view to obtain a clear frame. U.S. Pat. Nos. 5,515,109-5,742,354-5,831,685-and 5,940,140, generate a clear frame with the subject in place. In all of the above referenced patents, the color of the colored backing consists of a selected dominant color such as Blue or Green, and all the above patents use the same basic elements in the equation, E_{c}=K{B−max(G,R)}, where E_{c} is the control signal that controls the signal level of the background scene.

Screen correction, if applied to a virtual studio, requires the correction to be applied to each frame in real time, because the video camera is often in motion to follow a moving actor. A clean plate must therefor be generated in real time from an image frame containing a subject.

People take a lot more pictures with the advent of the cell phone camera. The cell phone is always with you and there is no cost to snap, look and delete. Desirable backgrounds are not always handy, nor are nice uniform colored backings. However, the stucco wall of a nearby building is sometimes available and often useful as a backing for producing composite images with beautiful backgrounds.

The term “backing,” in photography, is a vertical wall, or a canvas either white or a color. It is any plain fairly uniform surface behind a subject when taking his picture to be composited into a beautiful background scene. The camera operator, looking at his camera viewing screen, sees his subject placed before a selected “background” scene that has replaced the plain “backing” by means of an image compositing process inside the camera. He positions his subject with respect to the background scene before depressing the “take” button.

The open blue sky is also acceptable as a backing even when its color varies dramatically. Looking up, the sky may appear to be quite blue, but as your gaze drops to the horizon it may appear to be gray or even a brilliant red. The sky and the stucco wall may both be acceptable backings for image compositing of a desired background scene using a cell phone camera, or other digital camera. However, with such backings, a clear frame is needed in the process of eliminating imperfections in the backing that may transfer to the composite image.

### BRIEF DESCRIPTION OF THE DRAWINGS

FIG. 1 illustrates the assignment of acceptance windows for tracking backing pixels whose RGB signal levels vary.

FIG. 2 illustrates the rate of backing luminance change as a function of the number of pixels between signal level steps.

FIG. 3, shows a logic diagram of the functions that produce a clear frame from an image frame containing a subject before a backing that varies in luminance and or color or both.

### SUMMARY OF THE INVENTION

A clear frame is produced when all of the backing pixels, not occluded by a subject, are identified as backing pixels. The remaining pixels are those comprising the subject. RGB signals comprising the subject are replaced with backing pixels by interpolation and extrapolation of backing pixel signal levels across the subject thereby creating a clear frame in which all pixels are backing pixels.

### DETAILED DESCRIPTION OF THE INVENTION

For backings that are multicolored or shades of gray or warm or cool whites or other colors, and may vary widely across the backing in both color and luminance, a more sophisticated process than currently available is required to produce a clear frame from these types of backings, without human intervention.

The luminance and color of backings may vary smoothly across the backing, either by rising or falling, or by rising and falling several times, depending largely upon the number of lighting fixtures used to illuminate the backing. In studio lighting, color changes are very small and due to different ages of the lamp bulbs in the lighting fixtures. An outdoor backing illuminated by sunlight, or open sky, tends to be quite uniform. When the sky itself is used as a backing its color may vary substantially from one part of the sky to another, such as from blue at the top to white, or gray, or pink, or orange, or red at the horizon. A tracking process is developed that identifies unobscured backing pixels and subject pixels, thus permitting the replacement of the subject pixels by backing pixels closely approximating the signal levels of those backing pixels hidden behind the subject. This process leaves a clear frame free of the subject, which is the objective of this invention.

### Finding a “Known” Backing Pixel

All of the following discussion is predicated upon identifying a pixel known to be on the backing. Such a known backing pixel is needed to initiate a tracking process that identifies all other backing pixels; the remaining pixels being subject pixels. There is no single pixel address in the image frame that one may be certain that it will never be occupied by a subject pixel, because subjects may occupy any position in front of the backing, including any one of the four corners. Since we are dealing with a photographer placing his subject in the most favorable position with respect to a selected background scene, that favorable position is not likely to be in the upper left corner of the image frame. It is difficult to imagine a photographer placing his subject up into a corner. This makes the pixel in the upper left corner an acceptable choice. While it would be a minor restriction, avoiding the placement of a subject in a designated corner can be stated as an operational requirement.

The backing area may vary in color and luminance but these variations are a smooth continuum and occupy large areas of the backing. Based on this continuum, other methods are possible for finding a pixel “known” to be on the unobscured backing.

A method for locating a known backing pixel classifies all pixels in the stored image frame by the signal level of each color. The color having the largest number of pixels at the same signal level, within a small tolerance, will represent backing areas. Designating a specific pixel from one of these backing areas becomes the “Known” backing pixel with a known address. The first pixel on a scan line entering into a backing area may be used as the designated “Known” backing pixel. It is the address of a pixel known to be on the backing, that is needed to begin a tracking process that independently follows small backing changes in the signal level of each of the three colors RGB.

A pixel's signal level is actually three signal levels; the red, green, and blue components of a particular hue. A pixel known to be on the backing must be determined for each new clear frame, and a new clear frame is needed for each picture. The clear frame must be continuously regenerated as the subject is being positioned with respect to a background scene.

### Backing Pixel Candidates

Unless otherwise specified, the term “pixel signal level” will refer independently to each of the three colors, Red, Green and Blue being stored at a given pixel. The dominant color will not always be the blue of a blue backing or of a blue sky. Green is an equally popular backing color. The dominant color of interior and exterior walls of many buildings is often an off-white. Its dominant color will most likely be Red. Red will be used in the following discussion.

Beginning with the Known backing pixel, its Red signal level is compared to the Red signal level of an adjacent pixel. If the difference between the Red signal levels are zero, within a small tolerance or window, the Red component of the adjacent pixel is accepted as a candidate for a backing pixel. This same procedure is repeated for the green signal, and for the blue signal. When the adjacent unidentified pixel signal level of each color falls within its window established at the known backing pixel, all three colors are successful candidates, and all three candidates must be present to qualify and accept the unidentified pixel as a known backing pixel.

Eventually a pixel will be examined where one or two or all three or its individual colors will fail to fit into the window prepared for each backing pixel color. This will occur when the pixel is that of a part of a subject. The fact that the signal level of only one color is above or below the acceptance window is enough to detect the presence of a subject, the use of the three candidates, with small windows, provides excellent discrimination between backing pixels and subject pixels.

### Signal Level Range

Many visual storage devices or memories for images use eight bit encoding to provide signal levels from 1 (one) to 255 levels. The smallest signal level increment is therefore 1 part out of 255. Cameras are adjusted manually or automatically to place white, such as a well illuminated white shirt, at a signal level of about 200. The signal levels from 200 to 255 are typically reserved by the camera for very bright objects such as sequins, reflections from glossy subjects, or a chrome bumper. The effective signal level range is therefore about 200 levels. Since white consists of equal levels of Red, Blue, and Green, then each color has a signal level range of 200. In a range of 200 levels, the difference between levels is one half of one percent. This luminance difference is also the limit of the human eye to detect a brightness change. Signal level changes of a given color below one half of one percent are not visible. A signal level of one unit, is one out of a range of two hundred units of signal level.

### The Backing Pixel Acceptance Window

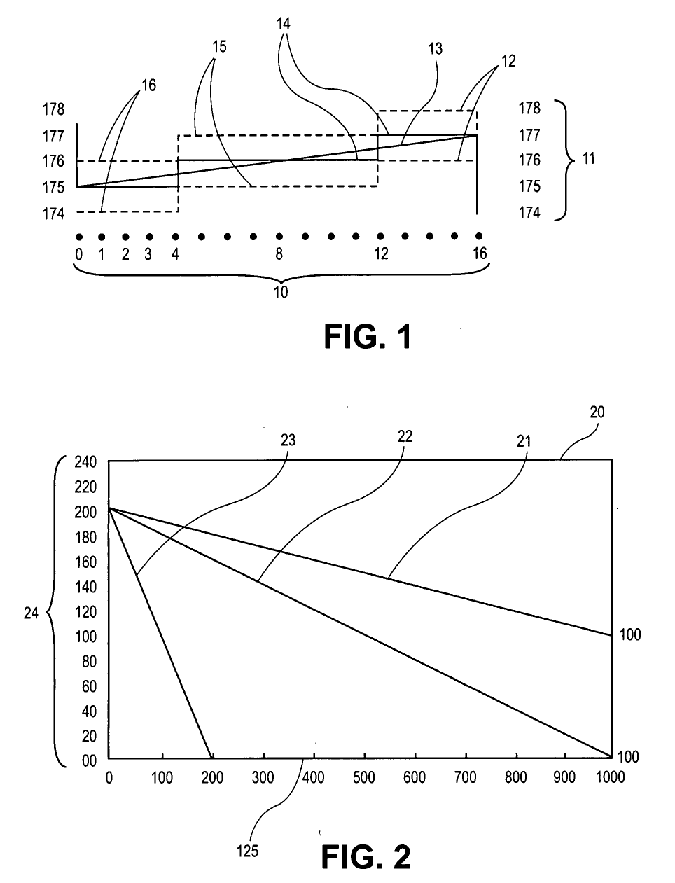

One should expect, that after tracking a number of backing pixels of equal signal level, that the signal level will increase or decrease as the backing luminance increases or decreases. FIG. 1, item 10 shows 17 dots representing 17 adjacent backing pixels along a horizontal scan line. The scale 11 is a scale of pixel signal levels that may vary from about 200 to a low of zero.

The straight line, item 13, slowly rising from level 175 to level 177, is an analogue signal level of a part of the backing whose red signal level is slowing rising. Pixel 0 at a signal level of 175 is a known backing pixel. Pixel I is unidentified, and may or may not be a backing pixel. A window is therefore assigned to pixel 0, of two units, consisting of one unit above and one unit below the known pixel's signal level as shown by the dotted lines, item 16. The window extends from level 174 to 176. If the red signal level of pixel 1 is no greater than 176 nor less than 174 then it is a backing pixel candidate. The identical procedure is applied to the green and blue signals.

If all three colors become candidates, the unidentified pixel is accepted as a known backing pixel. This process continues for pixel 2, 3, and 4. The analogue signal has been digitized. At pixel 4 the signal level increases by one unit, and the window 15 rises by one unit. This is the point where the analogue signal level passed the half way point between level 175 and 176. At pixel 12, the signal level rises by one more level. The window also rises by one unit as shown by the dotted lines, item 12. All known backing pixels will be assigned the same window of plus and minus one unit. This process of assigning a two unit window applies to all three colors at any pixel signal level, whether rising or falling.

The signal level of each of the three colors of the adjacent pixel must not exceed nor fall below its assigned window. If any one of the three colors is rejected, the pixel must be a part of the subject, or part of the backing in the subject's shadow. The assignment of a window for tracking of the backing through a shadow will be covered in a later section.

While FIG. 1 shows a backing of rising luminance, steps such as 4 and 12 would fall if a backing area was falling in luminance. It is not known if a next pixel will rise or fall. The window extends one unit above and one unit below a known pixel's signal level, and will therefore track backing pixels through cycles of rising and falling.

FIG. 2 shows a box 20 whose horizontal axis 25 represents 1,000 pixels across the image of the backing. Its vertical axis 24 represents signal level from zero to 200. Line 21 starting at a signal level of 200, drops smoothly across the image to a level of 100. This is a 50 percent drop in luminance, and occurs over the 1000 pixel width of the image. With minimal steps of one unit of signal level, after every 10 pixels there will be one downward step for a total of 100 steps. If luminance dropped from 200 to zero across the image, line 22, it would require a total of 200 steps, occurring after every 5 pixels. If the window was dropped by one unit after each pixel, line 23, a 200 signal level would drop to zero in 200 pixels. This is only one fifth of the width of the image. FIG. 2 is intended to show that a two unit window is large enough to permit tracking a very steep signal rise or fall.

### Tracking Backing Pixels

The blue or green screen in a virtual studio will vary in lighting levels perhaps by as much as 50%, but color varies very little. There are no sudden changes to challenge the tracking process. The internal walls of a building, when used as a backing, will vary smoothly, but by as much as 50% or more in luminance because of poorly placed lighting fixtures. Little more than small changes in color is likely even when using mixed fluorescent and incandescent lamps. Exterior walls illuminated by sun and sky will show very little change in either lighting level or color, during the time a camera shutter is open.

No significant changes in luminance or color are to be expected of a clear blue sky or an overcast sky used as a backing.

When the sky is chosen as a backing, its color can vary from a clear blue and fall to gray, white, pink, orange, or red at the horizon. Since the colors RGB are tracked independently of each other, red could be rising, while blue is falling. The tracking process insures that even though the backing color is changing across the backing from blue to red, every accepted pixel is a backing pixel.

When one or more of the colors of any pixel fails to become a candidate for acceptance as a backing pixel, that pixel is either in a subject area, or in a backing area in the shadow of a subject. Tracking backing pixels in a shadow area will be described in a later section.

Using the backing pixel tracking process, and in an orderly manner, the contiguous backing pixels in the image frame are identified. Backing pixels not identified consist of small islands isolated from the main body of backing pixels, such as under the arm when one places his hand on his hip, or places his hands together over his head. Other holes occur as small gaps between tree branches, or a lattice structure.

When a scan line runs out of backing pixels because it reaches a subject pixel, the signal levels of the last backing pixel can be extrapolated across subject pixels in a search for isolated backing pixels. In these cases the assigned window may be progressively increased, for each of the three colors being tracked, to increase the probability of identifying small backing areas that appear through small gaps or holes in the subject. As distance increases and tolerance is increased, discrimination between backing and subject pixels is decreased. Also, the colors of the backing may have changed by an amount proportional to the distance of the extrapolation.

Extrapolating the RGB signal levels of known backing pixels across the subject from left to right, and from right to left and from top to bottom will likely have three different extrapolation distances. The shorter extrapolation will use the smallest window and provide the best discrimination between backing and subject. A small isolated group of pixels may be backing pixels. If one of these pixels is assigned a two unit window to permit tracking, and the tracking accepts a number of such pixels as candidates, they may be accepted as backing pixels. The tracking process will reject any pixel containing any element of a subject.

Backing pixels in isolated areas can also be identified by tracking the hue of backing pixels rather than signal level.

In most cases, the hue of the backing is essentially constant. This means that if the R G B levels of a known backing pixel are compared to the r g b levels of an adjacent pixel, and the ratios R/r, G/g, and B/b are identical to each other, within a small tolerance, the adjacent pixel is a likely backing pixel. The use of ratios permit detection of backing pixels regardless of how sharply signals drop or rise. For this reason, backing pixels detected by ratios may be accepted as a valid backing pixel if its RGB signal levels fall within the upper and lower RGB signal range of known backing pixels.

### Replacing Subject Pixels

Having located contiguous backing pixels, and backing pixels in isolated backing areas, the remaining pixels are subject pixels. The RGB signal levels of backing pixels at the edge of a subject may be extrapolated a short distance into the subject area to replace these subject pixels with backing pixels. These short extrapolations are fairly accurate, and extend over a semi transparent subject edge. The short extrapolations may be joined across the subject by interpolation.

Backing pixels just outside the subject edge may also be extrapolated and or interpolated across the entire subject area. The combined influence of extrapolation from two or more directions will provide a more accurate approximation of backing pixel signal levels of pixels behind the subject. The replacement of the backing pixels behind the subject are desired to make a clear frame. The backing pixels that fill this area require no significant accuracy, since this area is always invisible to the camera. Pixel scanning may be from either side, from top or bottom, and at an angle. When all subject pixels have been replaced by extrapolated and or interpolated backing signals, the subject will have disappeared, leaving a clear frame.

### Shadow Removal

A clear frame is an image frame unobscured by anything between the camera and backing. A shadow is therefor a part of the subject since it partially obscures the backing. One cannot generate a clear frame unless a subject's shadow is removed as well as the subject.

The tracking of backing pixel luminance signal levels as described earlier will identify those backing pixels in a subject's shadow to be part of the subject. For this reason, in early testing, the subject was moved away from the backing to avoid a shadow. The tracking process for developing a clear frame as described earlier may also be used to track and remove a subject's shadow.

There are two kinds of shadows; those made with controlled lighting where key and fill lighting are at the same color temperature, typically at 3200 degrees K, and those shadows made outdoors with a sunlight key at 5000 degrees K, whose shadows are illuminated with 12,000 degree K blue sky light.

The tracking program of comparing a known pixel with an adjacent unknown pixel will identify backing pixels on the backing up to the edge of a subject or its shadow. The unidentified pixel, adjacent to the known backing pixel, may be a subject, a subject's shadow having the same hue as the backing, or a subject' shadow having a hue unlike that of the backing. The first step is to identify the unknown pixel as a subject or a shadow. The unidentified pixel is assigned the customary window of 2 units and tracking of adjacent pixels is begun with the unidentified pixel. If tracking does not occur over many pixels, the unidentified pixel is that of a subject, and no additional test is needed. If tracking is continued over many pixels, a shadow area has been identified.

The next test is to determine that the shadow has or does not have the same hue as the backing. If the ratios of the known pixel over the unknown pixel, R/r, G/g, and B/b are identical to each other, the shadow is the same hue as the backing. In this event each of the shadow pixels when multiplied by the above ratio will cause the shadow to disappear.

If the above ratios are not identical, within a small tolerance, the shadow is in an uncontrolled environment and its hue will not match that of the backing. In this event, the pixel adjacent to the known backing pixel is treated as a backing pixel of a different color, and its RGB components are assigned the two unit window to permit tracking of the off-color shadow. Since sunlight is quite uniform, the shadow it makes is also quite uniform. Tracking these shadow pixels will identify them. The RGB levels of all of the off-color shadow pixels are then replaced with the RGB signal levels of the unshadowed backing, thus eliminating the shadow.

Having identified the backing pixels not shadowed and backing pixels being shadowed, the remaining pixels are subject pixels, and the addresses of pixels in these three groups are retained. After removing the shadows, the subject pixels may now be replaced with backing pixels by interpolation and extrapolation as described above. If desired, the shadow can be readily added to the composite image at any desired density by reducing the signal level of the background control signal, of Equation 1, in the pixel addresses of the original shadow.

### Image Blur

Small abrupt luminance changes may be visible when one uses the external stucco wall of a building as a backing. From a modest distance, a stucco finish may look to the camera as having a superimposed noise. Inducing a blur compensates for the texture of the backing and also reduces camera noise that appears at lower light levels. The blurring of pixels by several methods is well known in the video industry.

### Implementation

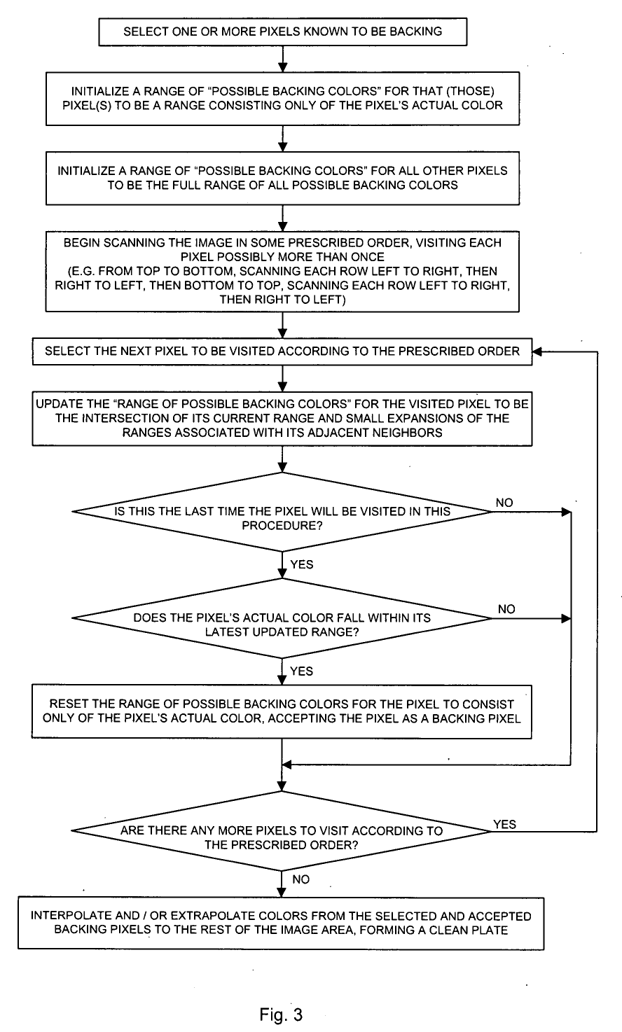

The steps shown in FIG. 3 for extracting a clear frame from an image, produced by a digital or cell phone camera, may be implemented in the software of a computer, such as the Ultimatte Composite Image Software. It may also be implemented in hardware such as the Ultimatte 10 image compositing hardware. Both are products available from Ultimatte Corporation of Chatsworth, Calif. A simplified software version may be added to digital and cell phone camera memory chips for the purpose of positioning a subject before a selected background. Hardware implementation is required if a clear frame is to be generated in real time. A software version is required if a clear frame is to become part of a computer image compositing program. The steps of comparing the level of two signals, the process of extrapolation and interpolation, the process of addition subtraction dividing multiplying and comparing ratios, as shown in the block diagram of FIG. 1, are common functions in this art.

We claim:

1. A method for extracting a clear frame from an image frame containing at least one subject disposed before a backing, whose color and luminance vary smoothly from one backing area to another, by replacing a subject's pixel signal levels with backing pixel signal levels, said method comprising the steps of:
a) selecting a known backing pixel and comparing RGB signal levels of an adjacent pixel with RGB signal levels of said known backing pixel and identifying said adjacent pixel as a backing pixel when its RGB signal levels are each within an assigned tolerance of the RGB signal levels of said known backing pixel,
b) continuing said comparisons of said known backing pixels with unidentified adjacent pixels until all pixels in the image frame have been examined and all backing pixels identified,
c) replacing the RGB signal levels of said at least one subject's pixels with the RGB signal levels of backing pixels located at opposite edges of said at least one subject by at least one of interpolation and extrapolation across the at least one subject thereby removing said at least one subject to leave a clear frame.

2. The method of claim 1 in which said selected backing pixel is identified as the pixel at a specified location.

3. The method of claim 1 in which said selected backing pixel is any one of many backing pixels all having identical signal levels within a selected tolerance.

4. The method of claim 1 in which said selected backing pixel is any designated pixel on a scanning line crossing a field of backing pixels.

5. The method of claim 1 in which said assigned tolerance is an acceptance window extending a predetermined distance above and a predetermined distance below the RGB signal levels of a known backing pixel.

6. The method of claim 1 in which said replacement of subject pixels by backing pixels is accomplished by extrapolation of the RGB signal levels of backing pixels, adjacent to said at least one subject's pixels, a predetermined distance into the subject area, followed by interpolation of said backing pixel signal levels across the remaining subject area,

7. The method of claim 1 in which said replacement of said at least one subject's pixels by backing pixels is accomplished by at least one of interpolation and extrapolation of the RGB signal levels of backing pixels located at opposite edges of the at least one subject.

8. The method of claim 1 in which said replacement of said at least one subject's pixels by backing pixels when one side of the at least one subject joins the edge of the image frame is accomplished by extrapolation of RGB signal levels of backing pixels to said image frame edge.

9. The method of claim 1 in which a shadow of the at least one subject, if present, is considered to be part of the at least one subject and is removed by replacing shadowed backing pixel signal levels with the signal levels of adjacent unobscured backing pixels by interpolation and extrapolation.

10. The method of claim 1 in which image noise and backing texture of a camera are reduced by blurring background pixels by a selected blurring method.

11. The method of claim 2 wherein the specified location is an upper left corner of the image frame.

12. The method of claim 19 wherein said selected blurring method is replacing the RGB signal levels of each backing pixel with the averaged RGB signal levels of a group of surrounding backing pixels.
